(19) United States
(12) Patent Application Publication
(10) Pub. No.: US 2017/0330439 A1
(43) Pub. Date: Nov. 16, 2017

(54) ALARM METHOD AND DEVICE, CONTROL DEVICE AND SENSING DEVICE

(71) Applicant: Beijing Xiaomi Mobile Software Co., Ltd., Beijing (CN)

(72) Inventors: Shiquan Zhou, Beijing (CN); Qiang Fu, Beijing (CN); Enxing Hou, Beijing (CN)

(73) Assignee: Beijing Xiaomi Mobile Software Co., Ltd., Beijing (CN)

(21) Appl. No.: 15/345,013

(22) Filed: Nov. 7, 2016

(30) Foreign Application Priority Data
May 10, 2016 (CN) 201610306121.8

(51) Int. Cl. G08B 21/18; G08B 17/10; G08B 21/12; G08B 23/00

(52) U.S. Cl. CPC G08B 21/182; G08B 23/00; G08B 17/10; G08B 21/12

(57) ABSTRACT

The present disclosure relates to an abnormality detection and alarm producing method and system, where the system includes a control device, a sensing device, and a smart device.

### CROSS-REFERENCE TO RELATED APPLICATIONS

The present application is based upon and claims priority to Chinese Patent Application No. 201610306121.8, filed May 10, 2016, the entire contents of which are incorporated by reference herein.

### TECHNICAL FIELD

The present disclosure generally relates to the field of smart home systems, and more particularly, to an alarm device, a control device, and a sensing device of a smart home system and methods for operating the smart home system.

### BACKGROUND

In related arts, a variety of sensing devices are installed in a smart home system. When abnormalities are detected by the sensing devices, the sensing devices can produce an alarm through their own alarm producing components. However, these sensing devices are not portable, and require cumbersome electrical wiring for each room, and thus power consumption for these sensing devices is relatively large.

### SUMMARY

According to an exemplary first aspect of the present disclosure, there is an abnormality detection and alarm producing method, the method including: receiving a notification message sent by a sensing device based on a detected abnormality; determining a smart device having a linkage relationship with the sensing device based on the notification message; and controlling the smart device to output alarm information.

According to an exemplary second aspect of the present disclosure, there is provided an abnormality detection and alarm producing method, the method including: determining whether an abnormality occurs in a monitoring area; and if it is determined that the abnormality occurs, sending a notification message, such that a smart device having a linkage relationship with a sensing device outputs alarm information.

According to an exemplary third aspect of the present disclosure, there is provided a control device including: a processor; and a memory for storing instructions executable by the processor; wherein the processor is configured to execute the instructions to: receive a notification message sent by a sensing device based on a detected abnormality; determine a smart device having a linkage relationship with the sensing device based on the notification message; and control the smart device to output alarm information.

According to an exemplary fourth aspect of the present disclosure, there is provided a sensing device including: a processor; and a memory for storing instructions executable by the processor; wherein the processor is configured to execute the instructions to: determine whether an abnormality occurs in a monitoring area; and if it is determined that the abnormality occurs, send a notification message, such that a smart device having a linkage relationship with a sensing device outputs alarm information.

According to an exemplary fifth aspect of embodiments of the present disclosure, there is provided a non-transitory readable storage medium including instructions, executable by a processor in an alarm device to implement a method, the method including: receiving a notification message sent by a sensing device based on a detected abnormality; determining a smart device having a linkage relationship with the sensing device based on the notification message; and controlling the smart device to output alarm information.

According to an exemplary sixth aspect of the present disclosure, there is provided a non-transitory readable storage medium including instructions, executable by a processor in an alarm device to implement a method, the method including: determining whether an abnormality occurs in a monitoring area; and if it is determined that the abnormality occurs, sending a notification message, such that a smart device having a linkage relationship with a sensing device outputs alarm information.

It is to be understood that both the foregoing general description and the following detailed description are exemplary and explanatory only and are not restrictive of the features described herein.

### BRIEF DESCRIPTION OF THE DRAWINGS

The accompanying drawings, which are incorporated in and constitute a part of this specification, illustrate embodiments consistent with the features described in this disclosure and, together with the description, serve to explain the principles of the features described in this disclosure.

FIG. 1 is a flow chart of logic describing an abnormality detection and alarm producing method according to an exemplary embodiment of the present disclosure.

FIG. 2 is a flow chart of describing another abnormality detection and alarm producing method according to an exemplary embodiment of the present disclosure.

FIG. 3 is a flow chart of logic describing another abnormality detection and alarm producing method according to an exemplary embodiment of the present disclosure.

FIG. 4 is an exemplary system diagram of a smart home system for implementing an abnormality detection and alarm producing method according to an exemplary embodiment of the present disclosure.

FIG. 5 is a block diagram of an alarm device according to an exemplary embodiment of the present disclosure.

FIG. 6 is a block diagram of an alarm device component according to an exemplary embodiment of the present disclosure.

FIG. 7 is a block diagram of another alarm device according to an exemplary embodiment of the present disclosure.

FIG. 8 is a block diagram of an alarm device component according to an exemplary embodiment of the present disclosure.

FIG. 9 is a block diagram of an alarm device component according to an exemplary embodiment of the present disclosure.

FIG. 10 is a block diagram of an alarm device component according to an exemplary embodiment of the present disclosure.

FIG. 11 is a block diagram of another alarm device according to an exemplary embodiment of the present disclosure.

FIG. 12 is a block diagram of an alarm device component according to an exemplary embodiment of the present disclosure.

FIG. 13 is a structural block diagram of an alarm device according to an exemplary embodiment of the present disclosure.

FIG. 14 is a structural block diagram of another alarm device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with the scope of the features related to this disclosure and as recited in the appended claims.

The terms used in the present disclosure only tend to depict specific embodiments, rather than restricting the present disclosure. Unless the exceptional case in which the context clearly gives supports, the singular forms “a”, “an”, and “the” used in the present disclosure and accompany claims are intended to include the plural forms. It should also be appreciated that the expression “and/or” used herein indicates including any and all possible combinations of one or more of the associated listed items.

It should be understood, although terms first, second, third and the like are used in the present disclosure to depict various information, such information is not restricted by these terms. These terms are only used to distinguish information of the same type from each other. For example, without departing from the scope of the present disclosure, the first information may also be referred to as the second information. Similarly, the second information may also be referred to as the first information. Depending on context, the word “if” used herein may be explained to “when” or “upon” or “in response to determination that . . . ”.

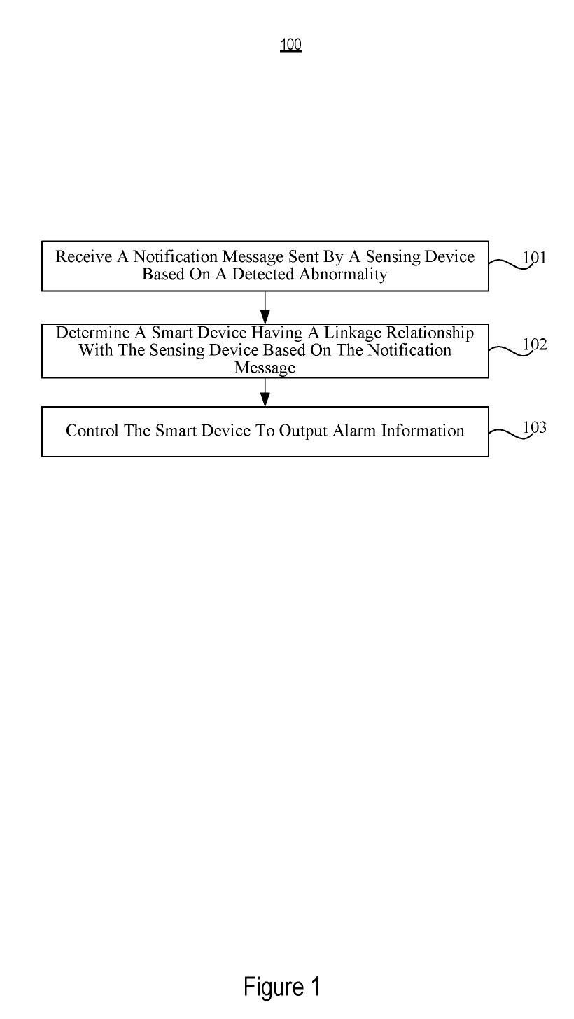

FIG. 1 is a flow chart of logic 100 describing an abnormality detection and alarm producing method according to an exemplary embodiment. As shown in FIG. 1, the method may be implemented by a control device, and may include the following steps.

In step 101, a notification message sent by a sensing device in response to the sensing device detecting an abnormality condition is received by the control device. The sensing device may include an infrared sensor for sensing infrared radiation emitted from objects, where the detection of infrared radiation may be interpreted as the presence of an object or movement of an object (i.e., a motion detector). The sensing device may further include a temperature sensor for sensing a temperature of an environment or temperature radiating from an object. The sensing device may further include a sound sensor (e.g., microphone) for detecting sounds. The sensing device may further include a gas (smoke) sensor for sensing smoke or other noxious gases. The abnormality condition sensed by the sensing device may be recognized as an abnormality by exceeding a respective condition threshold. For example, motions detected by the motion detector during certain predetermined time periods (e.g., motions after 10:00 p.m.), may be recognized as an abnormality condition. A temperature exceeding a predetermined heat threshold, or a temperature below a predetermined cold threshold, may also be recognized as an abnormality condition. A sound exceeding a certain noise measurement threshold (e.g., decibels) may also be considered an abnormality condition. A detection of certain gases, and/or a detection of certain gases in an amount or concentration exceeding a gas level threshold, may also be considered an abnormality condition.

The control device in the embodiments of the present disclosure may include computing devices operating as a center control device of a smart home system, such as a server, a router, a gateway, and the like. The control device may further include smart devices in the smart home system, such as smart appliances (e.g., smart thermostat, smart refrigerator, smart dryer, smart washer, smart microwave, smart dishwasher, smart range) that receive or sense input information and control an operational process based on the input information, and the like. The control device may be connected with one or more smart appliances in the smart home system, as well as the sensing device in the smart home system. The computing devices comprising the smart home system may communicate via a wireless communication protocol, such as Wi-Fi (Wireless Fidelity), Bluetooth, Zigbee, and the like. The computing devices comprising the smart home system may also communicate via a wired communication, such as through a wired connection to the Internet.

According to embodiments where the router is operating as the center control device (e.g., smart router device), the router capabilities includes not only conventional router characteristics, but also may further include an independent operating system and a memory storage disk, where a size of the storage space of the disk can be flexibly set as needed (e.g., 1 Terabyte of memory storage capacity).

The smart device in the present disclosure may include smart appliances, which are smart devices capable of outputting the alarm information in the form of sound, light or others.

In step 102, a smart device having a linkage relationship with the sensing device is determined based on the notification message.

In step 103, the smart device is controlled to output alarm information.

In the above embodiments, when the notification message sent by the sensing device based on the detected abnormality is received, the control device can control the smart device having the linkage relationship with the sensing device to output alarm, such that a user can know the abnormality occurred in the monitoring area in time, and thus the security of a smart home system can be improved. Furthermore, an alarm unit in the sensing device can be omitted, such that a size of the sensing device can be reduced, and thus power consumption can be reduced and costs can be saved.

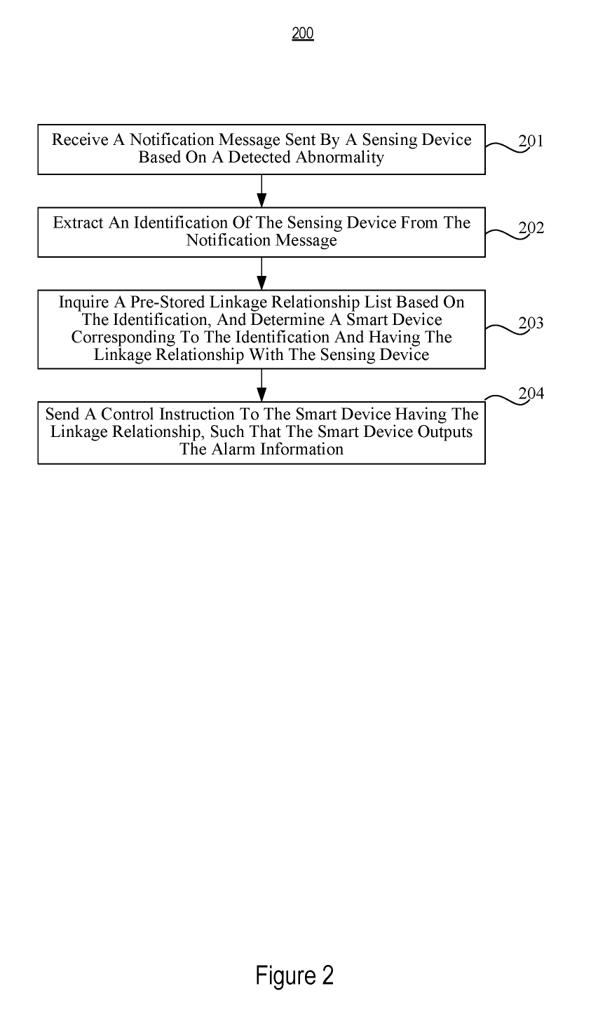

FIG. 2 is a flow chart of logic 200 describing another abnormality detection and alarm method according to an exemplary embodiment. As shown in FIG. 2, the method may be implemented by a control device or a smart appliance, and can include the following steps.

In step 201, a notification message sent by a sensing device in response to the sensing device detecting an abnormality condition is received by the control device.

The abnormality condition detected by the sensing device may include: the infrared sensor detecting infrared rays emitted by a human body within a monitoring area covered by the infrared sensor; sensing a temperature by the temperature sensor that is higher than a preset temperature threshold; sensing a smoke concentration by a smoke detector that is higher than a preset concentration threshold, and so on. After the abnormality condition is detected by the sensing device, the sensing device may transmit the notification message describing the abnormality condition to the control device. The notification message may further identify the sensing device that detected the abnormality condition.

In another implementation, when the abnormality is detected, the sensing device may further broadcast the notification message to one or more smart appliances connected to a common smart home system as the sensing device.

In step 202, an identification of the sensing device is extracted from the notification message.

In step 203, a pre-stored linkage relationship list is referenced to identify a smart device that is linked to the sensing device identified in the notification message. The pre-stored linkage relationship list may be stored in a database or other memory storage configuration in the control device, or in communication with the control device. The

The control device may pre-store the linkage relationship list, in which entries defining linkage relationships between a sensing device and a corresponding smart device are recorded. By referencing the linkage relationship list, the control device may determine the identification of the smart device corresponding to the sensing device identified in the notification message.

The process of storing the entries defining the linkage relationships to the linkage relationship list correspondingly may include: receiving, at the control device, a linkage instruction including the identification of the sensing device and an identification of the smart device having the linkage relationship with the sensing device; and storing a corresponding linkage relationship relating the sensing device to the smart device in the linkage relationship list. The linkage instruction may be uploaded to the control device as part of a mass data import transfer, or individually input by a user of the control device. The linkage relationships that match smart devices to sensing devices can be set through a smart home App (Application) running on a smart control device.

According to some embodiments, when a smart appliance receives the notification message, the smart appliance will extract the identification of the sensing device from the notification message, and reference the linkage relationship list to determine the smart device having the linkage relationship to the sensing device identified from the notification message. If the smart device identified from the linkage relationship matches the smart appliance receiving the notification message, this indicates that the smart appliance having received the notification message is also responsible for producing an alarm notification in view of the sensed abnormality condition.

It should be noted that the number of smart devices having the linkage relationship with the sensing device can be more than one, thus the alarm notification may be simultaneously produced in a variety of ways on a plurality of smart devices.

In step 204, the control device transmits a control instruction to the smart device determined to have the linkage relationship with the sensing device identified from the notification message, where the control instruction instructs the smart device to produce the alarm notification. The alarm notification may be alphanumeric message, an audible message, a haptic feedback message, a visual light indicator, or some combination of the like.

The smart device may include devices capable of outputting the alarm notification information, such as a smart radio, a sound equipment and the like; the alarm information may include sound, light, voice and other forms. For example, the radio can alarm at maximum volume.

When it is determined that the smart device itself has the linkage relationship with the sensing device, the smart device may initiate its own alarm mode, and output the alarm notification information based on the alarm mode. The alarm mode can be set to modes, such as a voice alarm, an alarm notification sent to a user computing device, and the like.

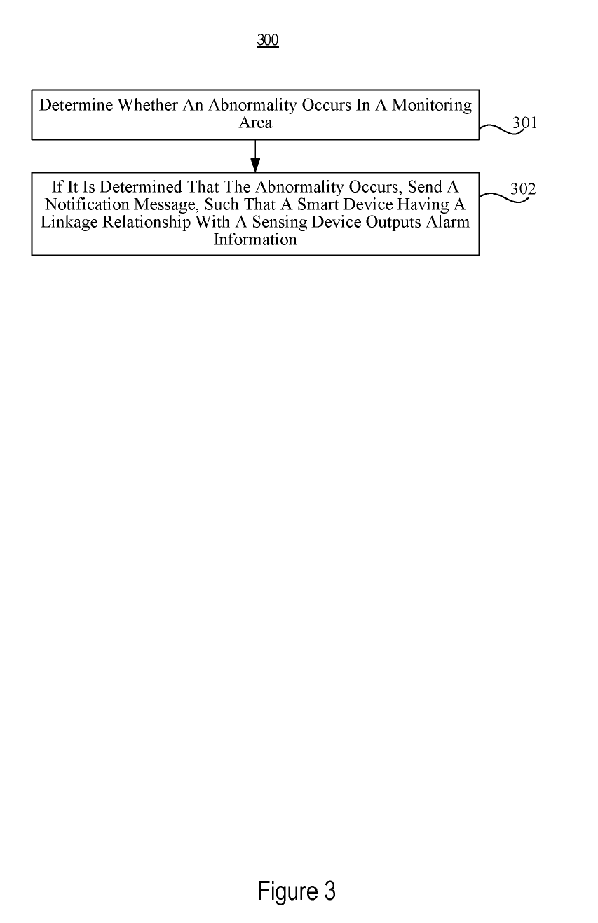

FIG. 3 is a flow chart of logic 300 describing another abnormality detection and alarm method according to an exemplary embodiment. As shown in FIG. 3, the method may be implemented by a sensing device, and may include the following steps.

In step 301, the sensing device may determine whether an abnormality condition occurs in a monitoring area being monitored by the sensing device.

Each sensing device in the smart home system may be configured to monitor and detect conditions within its own monitoring area. For example, an infrared sensing device may detect for infrared rays existing within a respective monitoring area; and when infrared rays are detected within the monitoring area, a determination is made that a person is located within the monitoring area, which may be further determined to be an abnormality condition.

In step 302, if it is detected that the abnormality occurs, a notification message is generated by the sensing device and transmitted to the control device, where the notification message includes information identifying the sensing device that detected the abnormality condition. Based on receiving the notification message, the control device may implement processes for controlling the alarm notification to be produced by a respective smart device having a linkage relationship with the sensing device.

When the abnormality condition is detected, the sensing device may transmit the notification message to the control device, or other smart appliance device for determining a smart device having the linkage relationship with the sensing device, and controlling the smart device determined to have the linkage relationship to output the alarm notification information. Thus, when the sensing device does not include an alarm unit, another device having the alarm unit and having the linkage relationship may be controlled to produce the alarm notification. Thus, the size and power consumption of the sensing device itself may be greatly reduced, and a related cost of operating the sensing device may be greatly reduced also.

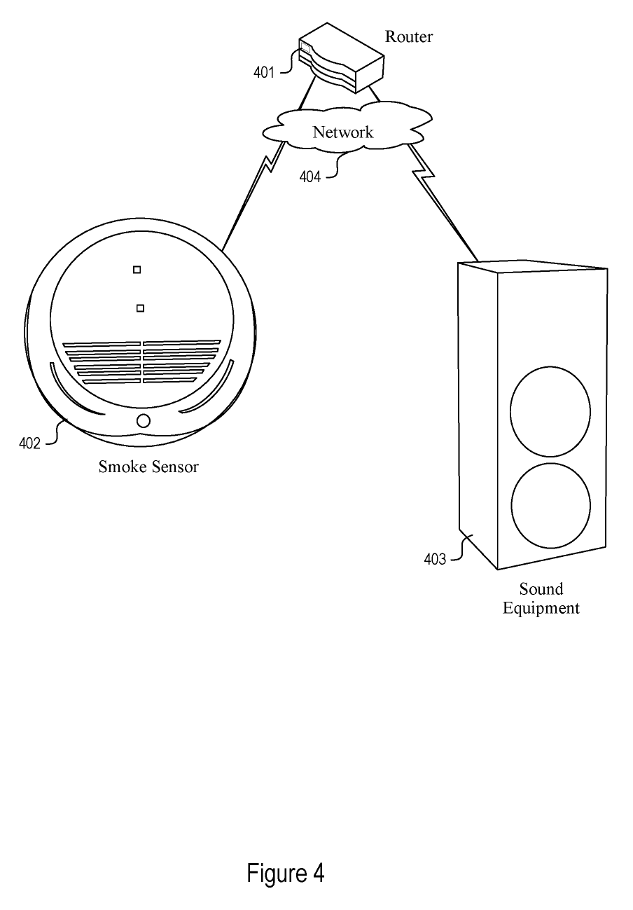

FIG. 4 is an exemplary system diagram of a smart home system 400 for implementing an abnormality detection and alarm method according to an exemplary embodiment of the present disclosure. In the scenario in FIG. 4, a smoke sensor 402 may be referenced as a sensing device, a router 401 may be referenced used as a control device, and a smart appliance 403 that includes sound equipment for implementing an alarm notification are shown. The components of the smart home system 400 communicate through a network 404.

The smoke sensor 402 detects smoke in a monitoring area (e.g., room) at a defined set time, and determines whether the detected smoke value is higher than a preset smoke threshold. If the detected smoke value is determined to exceed the preset smoke threshold, a notification message is generated by the smoke sensor 402 that identifies the smoke sensor 402 and describes the heightened smoke levels as an abnormality condition, and transmits the notification message to the router 401.

The router 401 receives the notification message, extracts the identification of the smoke sensor 402 from the notification message, searches a pre-stored linkage relationship list stored within a memory of the router 401, and determines the identification of the smart appliance 403 described as having the linkage relationship with the smoke sensor 402. In the present embodiment, the smart appliance includes the sound equipment.

Then, the router 401 transmits control instructions to the smart appliance 403, the smart appliance 403 receives the control instructions, and outputs an audible alarm notification, so as to remind the user to view what happens in the monitoring area in time. The alarm notification may be a spoken warning message to check on the room where the heightened smoke levels were detected, or another warning message to leave the room due to the heightened smoke levels detected in the room.

The process related to the abnormality detection and alarm producing methods described in connection with FIG. 1 to FIG. 3 may also be implemented by the smart home system 400 in FIG. 4, and thus repeated descriptions will not be further elaborated herein.

Corresponding to the above-mentioned abnormality detection and alarm producing methods, the present disclosure also provides embodiments of an alarm device and a control device and a sensing device in which the alarm device is installed.

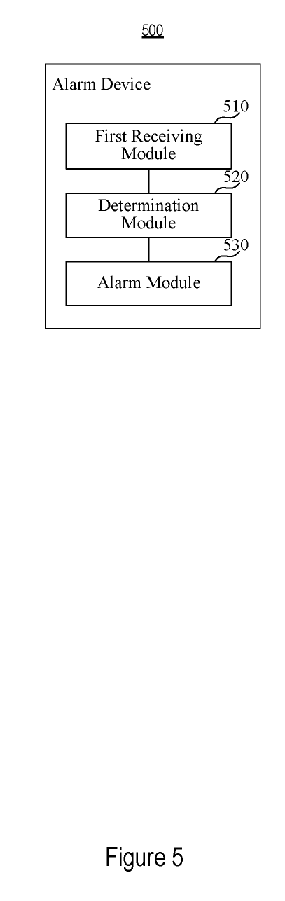

FIG. 5 is a block diagram of an alarm device 500 according to an exemplary embodiment of the present disclosure. As shown in FIG. 5, the alarm device 500 may be installed within a control device, and used to perform the method described in FIG. 1. The alarm device 500 includes: a first receiving module 510, a determination module 520, and an alarm module 530.

The first receiving module 510 is configured to receive a notification message sent by a sensing device in response to detecting an abnormality condition.

The determination module 520 is configured to determine a smart device having a linkage relationship with the sensing device identified in the notification message received by the first receiving module 510.

The alarm module 530 is configured to control the smart device determined by the determination module 520 to output alarm notification information.

In the above embodiments, when the notification message sent by the sensing device based on the detected abnormality condition is received, the control device may control the smart device having the linkage relationship with the sensing device to output the alarm notification, such that a user may know the abnormality condition occurred in the monitoring area in time, and thus the security of a smart home system can be improved. As an added benefit, a separate alarm unit in the sensing device can be omitted, such that a size of the sensing device can be reduced, and thus power consumption can be reduced and costs can be saved.

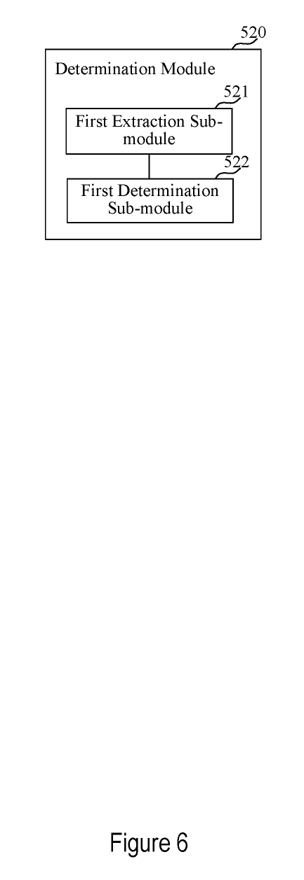

FIG. 6 is a block diagram of the determination module 520 included in the alarm device 500 shown in FIG. 5. As shown in FIG. 6, on the basis of the above embodiment shown in FIG. 5, the determination module 520 includes: a first extraction sub-module 521 and a first determination sub-module 522.

The first extraction sub-module 521 is configured to extract an identification of the sensing device from the notification message.

The first determination sub-module 522 is configured to reference a pre-stored linkage relationship list based on the identification extracted by the first extraction sub-module 521, and determine a smart device having the linkage relationship with the sensing device identified in the notification message.

In the above embodiments, the control device can determine the smart device having the linkage relationship with the sensing device based on the pre-stored linkage relationship list, and control the smart device to alarm. Thus, the existing smart appliance is effectively utilized, and cost of the sensing device is saved.

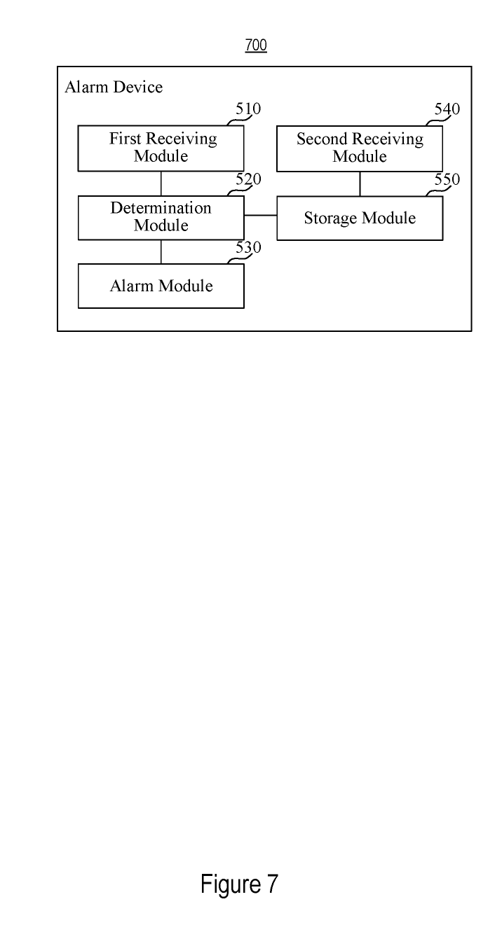

FIG. 7 is a block diagram of another exemplary alarm device 700 according to an exemplary embodiment of the present disclosure. As shown in FIG. 7, the alarm device 700 may further include a second receiving module 540 and a storage module 550, in addition to the components included in alarm device 500.

The second receiving module 540 is configured to receive a linkage instruction describing the identification of the sensing device and an identification of the smart device having the linkage relationship with the sensing device.

The storage module 550 is configured to store a linkage relationship corresponding to the identification of the sensing device and the identification of the smart device received by the second receiving module 540 in the linkage relationship list.

In the above embodiments, the control device can bind the identification of the smart device having the linkage relationship based on the linkage instruction sent by the sensing device or other smart devices, in order to find and determine the smart device having the linkage relationship with the sensing device.

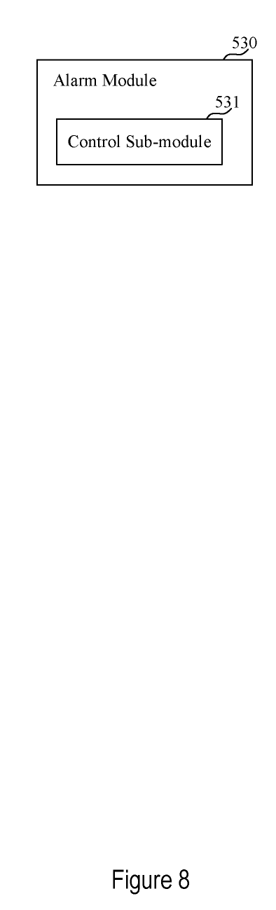

FIG. 8 is a block diagram of the alarm module 530 included in either alarm device 500 or alarm device 700 according to an exemplary embodiment of the present disclosure. As shown in FIG. 8, the alarm module 530 may include: a control sub-module 531.

The control sub-module 531 is configured to send a control instruction to the smart device determined to have the linkage relationship within the sensing device that detected the abnormality condition, such that the smart device outputs the alarm notification information.

In the above embodiments, after the smart device having the linkage relationship with the sensing device is determined, the control device can send the control instruction to the smart device, such that the smart device outputs the alarm notification information. Thus, the existing smart appliance is effectively utilized to produce the alarm notification. Furthermore, there may be more than one smart devices having the linkage relationship with the sensing devices, and thus a user may be reminded of the abnormality condition from a plurality of smart devices.

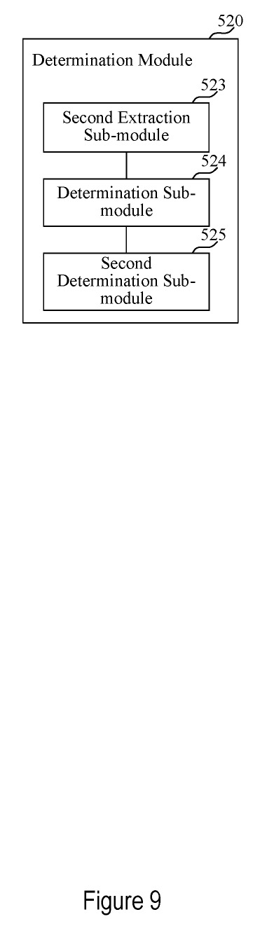

FIG. 9 is a block diagram of the determination module 520 that may be included in alarm device 500 or alarm device 700 according to an exemplary embodiment of the present disclosure. As shown in FIG. 9, the determination module 520 may include: a second extraction sub-module 523, a determination sub-module 524 and a second determination sub-module 525.

The second extraction sub-module 523 is configured to extract an identification of the sensing device from the notification message.

The determination sub-module 524 is configured to determine whether a pre-stored identification of a smart device having a linkage relationship with itself is consistent with the identification of the sensing device extracted by the second extraction sub-module 523.

The second determination sub-module 525 is configured to, when it is determined by the determination sub-module 524 that the stored identification of the smart device is consistent with the identification of the sensing device, determine that the smart device itself is the smart device having the linkage relationship with the sensing device.

In the above embodiments, the control device can be the smart appliance in the smart home system, wherein the smart appliance determines whether the smart appliance itself is a smart device having the linkage relationship with the abnormality condition detecting sensing device; and if it is determined that the smart appliance is the smart device, outputs the alarm information. A variety of alarm outputs are provided.

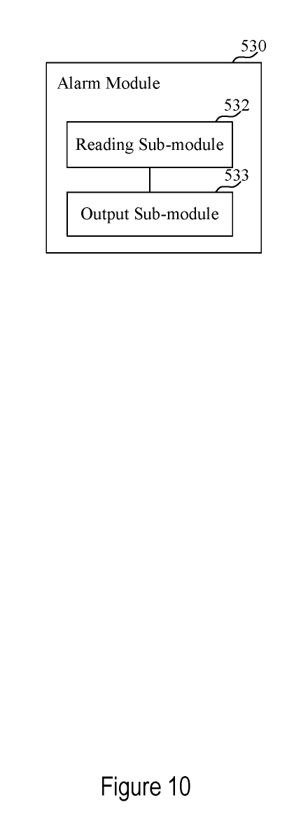

FIG. 10 is a block diagram of the alarm module 530 that may be included in alarm device 500 or alarm device 700 according to an exemplary embodiment of the present disclosure. As shown in FIG. 10, the alarm module 530 may include: a reading sub-module 532 and an output sub-module 533.

The reading sub-module 532 is configured to read a preset alarm mode. The preset alarm mode may be included as part of a set of alarm modes available on the corresponding smart device.

The output sub-module 533 is configured to output the alarm notification information based on the alarm mode read by the reading sub-module 532.

The above alarm information may include: any one or more of a sound alarm, a light alarm, a vibration alarm, and an alarm notification sent to a user terminal.

In the above embodiments, the smart device having the linkage relationship with the abnormality condition detecting sensing device can send the alarm in a variety of ways, in order to remind the user to view the abnormality in time.

The above alarm device components shown in FIG. 5 to FIG. 10 may be applied in the control device.

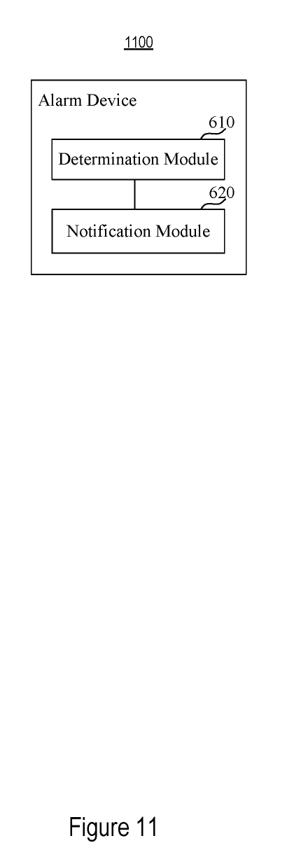

FIG. 11 is a block diagram of another alarm device 1100 according to an exemplary embodiment of the present disclosure. As shown in FIG. 11, the embodiment may be applied in a sensing device, and is used to perform the method shown in FIG. 3. The alarm device 1100 may include a determination module 610 and a notification module 620.

The determination module 610 is configured to determine whether an abnormality condition occurs in a monitoring area.

The notification module 620 is configured to, when it is determined by the detection module 610 that the abnormality occurs, generate a notification message to include identification of the sensing device and identification of the abnormality condition, and transmit the notification message to the control device, in order for a smart device having a linkage relationship with the sensing device outputs alarm notification information corresponding to the detected abnormality condition.

In the above embodiments, when the abnormality condition is detected, the sensing device may send the notification message, such that the control device or the smart appliance in the smart home system determines a device having the linkage relationship with the sensing device, and controls the device having the linkage relationship to output the alarm notification information. Thus, the sensing device in the embodiments of the present disclosure may not have an alarm unit, that is, the device having the alarm unit and having the linkage relationship can be controlled to produce the alarm notification. Thus, the size and power consumption of the sensing device of the present embodiments are greatly reduced, and cost is greatly reduced either.

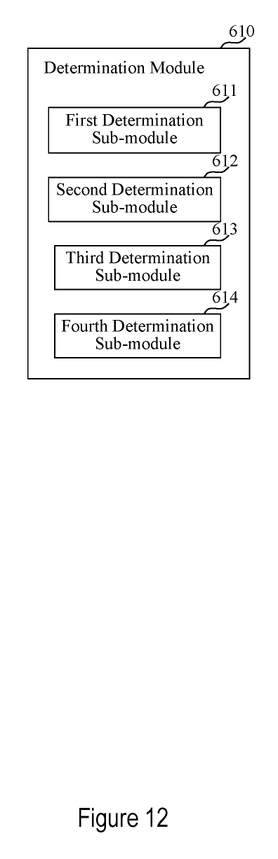

FIG. 12 is a block diagram of the determination module 610 included in the alarm device 1100 according to an exemplary embodiment of the present disclosure. As shown in FIG. 12, the determination module 610 may include any one or more of the following sub-modules: a first determination sub-module 611, a second determination sub-module 612, a third determination sub-module 613 and a fourth determination sub-module 614.

The first determination sub-module 611 is configured to determine whether infrared information is detected in the monitoring area.

The second determination sub-module 612 is configured to determine whether a detected temperature value is higher than a temperature threshold.

The third determination sub-module 613 is configured to determine whether a detected smoke concentration is higher than a smoke threshold.

The fourth determination sub-module 614 is configured to determine whether a detected sound decibel is higher than a sound threshold.

In the above embodiments, the sensing device can determine whether the abnormality occurs based on factors, such as detected temperature, infrared information, and the like, in order to ensure the security of the smart home system in many ways.

The above alarm device embodiments shown in FIG. 11 to FIG. 12 may be applied in a sensing device.

With respect to the devices in the above embodiments, the specific manners for performing operations for individual modules therein have been described in detail in the embodiments regarding the methods, which will not be elaborated herein.

For device embodiments, since they are substantially corresponding to the method embodiments, the relevant contents may be referred to some explanations in the method embodiments. The above-described device embodiments are only illustrative. The units illustrated as separate components may be or may not be separated physically, the component used as a unit display may be or may not be a physical unit, i.e., may be located at one location, or may be distributed into multiple network units. A part or all of the modules may be selected to achieve the purpose of the solution in the present disclosure according to actual requirements. The person skilled in the art can understand and implement the present disclosure without paying inventive labor.

Corresponding to FIG. 1, the present disclosure also provides a control device, including a processor; and a memory for storing instructions executable by the processor; wherein the processor is configured to:

receive a notification message sent by a sensing device based on a detected abnormality;

determine a smart device having a linkage relationship with the sensing device based on the notification message; and

control the smart device to output alarm information.

Corresponding to FIG. 3, the present disclosure also provides a sensing device, including a processor; and a memory for storing instructions executable by the processor; wherein the processor is configured to:

determine whether an abnormality occurs in a monitoring area; and

if it is determined that the abnormality occurs, send a notification message, such that a smart device having a linkage relationship with a sensing device outputs alarm information.

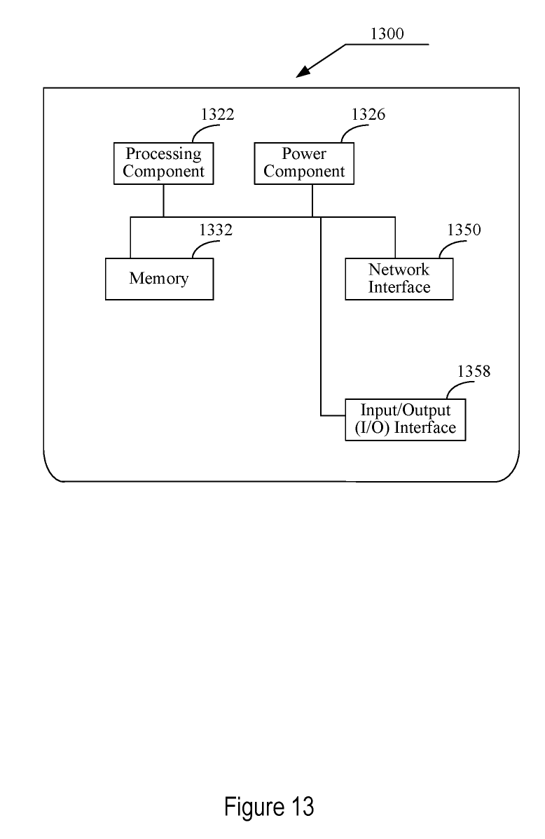

FIG. 13 is a structural block diagram of an alarm device 1300 according to an exemplary embodiment (a control device side). As shown in FIG. 13, for example, the device 1300 may be provided as a routing device. Referring to FIG. 13, the device 1300 includes a processing component 1322 that further includes one or more processors, and memory resources represented by a memory 1332 for storing instructions executable by the processing component 1322, such as application programs. The application programs stored in the memory 1332 may include one or more modules each corresponding to a set of instructions. Further, the processing component 1322 is configured to execute the instructions to perform the above alarm methods.

The device 1300 may also include a power component 1326 configured to perform power management of the device 1300, wired or wireless network interface(s) 1350 configured to connect the device 1300 to a network, and an input/output (I/O) interface 1358. The device 1300 may operate based on an operating system stored in the memory 1332, such as Windows Server™, Mac OS X™, Unix™, Linux™, FreeBSD™, or the like.

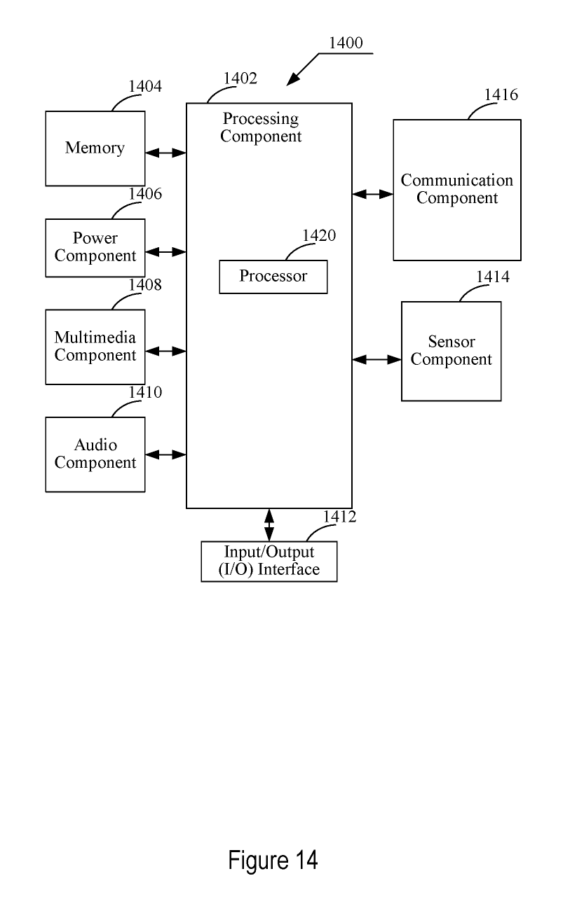

FIG. 14 is a structural block diagram of an alarm device 1400 according to an exemplary embodiment of the present disclosure (a sensing device side). As shown in FIG. 14, for example, the device 1400 may be a mobile phone having a routing function, a computer, a digital broadcast terminal, a messaging device, a gaming console, a tablet, a medical device, exercise equipment, a personal digital assistant, and the like.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400.

The multimedia component 1408 includes a screen providing an output interface between the device 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G or 3G or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 1404 including instructions executable by the processor 1420 in the device 1400, for performing the above-described methods. For example, the non-transitory computer-readable storage medium may be a ROM, a RAM, a CD-ROM, a magnetic tape, a floppy disc, an optical data storage device, and the like.

Each module, submodule, or unit discussed above for FIGS. 5-12, such as the first receiving module, the determination module, the alarm module, the first extraction and determination sub-modules, the second receiving module, the control sub-module, the second determination module and the notification module may take the form of a packaged functional hardware unit designed for use with other components, a portion of a program code (e.g., software or firmware) executable by the processor 1420 or the processing circuitry that usually performs a particular function of related functions, or a self-contained hardware or software component that interfaces with a larger system, for example.

The embodiments of the present disclosure also provide a non-transitory computer-readable storage medium. When the instructions in the storage medium are executed by the processor of the control device (such as a server, a router, or a smart appliance), the control device may be caused to perform an alarm method including:

receiving a notification message sent by a sensing device based on a detected abnormality;

determining a smart device having a linkage relationship with the sensing device based on the notification message; and

controlling the smart device to output alarm information.

The embodiments of the present disclosure also provide a non-transitory computer-readable storage medium. When the instructions in the storage medium are executed by the processor of the sensing device, the sensing device may be caused to perform an alarm method including:

determining whether an abnormality occurs in a monitoring area; and

if it is determined that the abnormality occurs, sending a notification message, such that a smart device having a linkage relationship with a sensing device outputs alarm information.

Other embodiments will be apparent to those skilled in the art from consideration of the specification and practice of the features disclosed here. This application is intended to cover any variations, uses, or adaptations of the features following the general principles thereof and including such departures from the present disclosure as come within known or customary practice in the art. It is intended that the specification and examples be considered as exemplary only, with a true scope and spirit of the features being indicated by the following claims.

It will be appreciated that the present disclosure is not limited to the exact construction that has been described above and illustrated in the accompanying drawings, and that various modifications and changes can be made without departing from the scope thereof.

1. An alarm notification method implemented by a control device, comprising:
receiving, from a sensing device, a notification message describing an abnormality condition sensed by the sensing device and including an identification of the sensing device;
determining a linkage relationship between the sensing device and a smart device based on the identification of the sensing device by the notification message; and
controlling the smart device to output an alarm notification.

2. The method of claim 1, wherein determining the linkage relationship comprises:
extracting the identification of the sensing device from the notification message;
referencing a linkage relationship list, stored in a memory of the control device, and identifying a linkage relationship corresponding to the smart device based on the identification of the sensing device; and
determining the smart device based on the identified linkage relationship.

3. The method of claim 2, further comprising:
receiving a linkage instruction for matching the sensing device and the smart device to create the linkage relationship linking the sensing device and the smart device; and
storing the linkage relationship in the linkage relationship list.

4. The method of claim 1, wherein controlling the smart device to output the alarm notification comprises:
transmitting a control instruction to the smart device having the linkage relationship, such that the smart device outputs the alarm notification as at least one of an audible message or a visual message.

5. The method of claim 1, wherein determining the linkage relationship comprises:
extracting the identification of the sensing device from the notification message;
referencing a linkage relationship list and identifying a linkage relationship corresponding to the smart device based on the identification of the sensing device; and
determining whether the smart device is the same as the control device.

6. The method of claim 5, wherein controlling the smart device to output the alarm notification comprises:
reading a preset alarm mode of the control device; and
outputting the alarm notification based on the preset alarm mode.

7. The method of claim 1, wherein the alarm notification comprises:
at least one of a sound alarm, a light alarm, a vibration alarm, and an alarm notification sent to a computing device.

8. An alarm notification method implemented by a sensing device, comprising:
monitoring a monitoring area by sensing conditions within the monitoring area;
determining whether an abnormality condition occurs in the monitoring area; and
when the abnormality condition is determined to occur in the monitoring area, transmitting a notification message to a smart device, such that the smart device having a linkage relationship with the sensing device outputs an alarm notification identifying the abnormality condition.

9. The method of claim 8, wherein determining whether the abnormality condition occurs in the monitoring area comprises at least one of:
determining whether infrared information is detected in the monitoring area;
determining whether a detected temperature in the monitoring area is higher than a temperature threshold;
determining whether a detected smoke concentration in the monitoring area is higher than a smoke threshold; and
determining whether a detected sound decibel in the monitoring area is higher than a sound threshold.

10. A control device, comprising:
a processor; and
a memory for storing instructions executable by the processor;
wherein the processor is configured to execute the instructions to:
receive, from a sensing device, a notification message describing an abnormality condition sensed by the sensing device and including an identification of the sensing device;
determine a linkage relationship between the sensing device and a smart device based on the identification of the sensing device by the notification message; and
control the smart device to output an alarm notification.

11. The device according to claim 10, wherein to determine the linkage relationship the processor is configured to execute the instructions to:
extract the identification of the sensing device from the notification message;
reference a linkage relationship list, stored in a memory of the control device, and identifying a linkage relationship corresponding to the smart device based on the identification of the sensing device; and
determine the smart device based on the identified linkage relationship.

12. The device according to claim 11, wherein the processor is further configured to execute the instructions to:
receive a linkage instruction for matching the sensing device and the smart device to create the linkage relationship linking the sensing device and the smart device; and
store the linkage relationship in the linkage relationship list.

13. The device according to claim 10, wherein to control the smart device to output the alarm notification the processor is configured to execute the instructions to:
transmit a control instruction to the smart device having the linkage relationship, such that the smart device outputs the alarm notification as at least one of an audible message or a visual message.

14. The device according to claim 10, wherein to determine the linkage relationship the processor is configured to execute the instructions to:
extract the identification of the sensing device from the notification message;
reference a linkage relationship list and identify a linkage relationship corresponding to the smart device based on the identification of the sensing device; and
determine whether the smart device is the same as the control device.

15. The device according to claim 14, wherein to control the smart device to output the alarm notification the processor is configured to:
reading a preset alarm mode of the control device; and
outputting the alarm notification based on the preset alarm mode.

16. The device according to claim 10, wherein the alarm notification comprises: at least one of a sound alarm, a light alarm, a vibration alarm, and an alarm notification sent to a computing device.

17. A non-transitory readable storage medium comprising processor executable instructions for implementing an alarm method, the processor executable instructions comprising instructions to cause a processor to:
receive, from a sensing device, a notification message describing an abnormality condition sensed by the sensing device and including an identification of the sensing device;
determine a linkage relationship between the sensing device and a smart device based on the identification of the sensing device by the notification message; and
control the smart device to output alarm notification.

18. The non-transitory readable storage medium of claim 17, wherein the processor executable instructions for determining the linkage relationship further comprise instructions for causing the processor to:
extract the identification of the sensing device from the notification message;
reference a linkage relationship list, stored in a memory of the control device, and identify a linkage relationship corresponding to the smart device based on the identification of the sensing device; and
determine the smart device based on the identified linkage relationship.

19. The non-transitory readable storage medium of claim 18, wherein the processor executable instructions further comprise instructions for causing the processor to:
receive a linkage instruction for matching the sensing device and the smart device to create the linkage relationship linking the sensing device and the smart device; and
store the linkage relationship in the linkage relationship list.

20. The non-transitory readable storage medium of claim 17, wherein the processor executable instructions for determining the linkage relationship further comprise instructions for causing the processor to:
extract the identification of the sensing device from the notification message;
reference a linkage relationship list and identifying a linkage relationship corresponding to the smart device based on the identification of the sensing device; and
determine whether the smart device is the same as the control device.
